(19) United States
(12) Patent Application Publication
(10) Pub. No.: US 2004/0245727 A1
(43) Pub. Date: Dec. 9, 2004

(54) Seal balancing system and method for high pressure and high velocity applications

(76) Inventor: Jack Bunn, Houma, LA (US)

Correspondence Address: BACON & THOMAS, PLLC, 625 SLATERS LANE, FOURTH FLOOR, ALEXANDRIA, VA, 22314

(21) Appl. No.: 10/455,381

(22) Filed: Jun. 6, 2003

(51) Int. Cl. F16J 15/16

(52) U.S. Cl. 277/500

(57) ABSTRACT

A seal balancing arrangement for a rotating or reciprocating shaft used in a high pressure and/or high velocity environment includes a plurality of grease balancing chambers each bordered by a pair of seals and filled with extreme pressure grease. The grease is compressed between the additional grease chambers by the movement of the first seal due to pressure acting on this seal by system internal pressures, thereby reducing pressure on the first seal while distributing the pressure between the remaining seals. The balancing chambers are arranged such that the grease in between the seals can be replenished through ports provided in a supporting housing, thereby extending the life of the seal assembly by allowing grease to lubricate the seal faces by extruding grease from each grease chamber.

### BACKGROUND OF THE INVENTION

1. Field of the Invention

This invention relates to a rotating shaft seal, and in particular to a system and method of maintaining the seal under conditions of high pressure or velocity, by distributing seal pressure across multiple grease chambers. The system and method of the invention may be used in a variety of rotary swivel and top drive drilling applications, as well as in reciprocating drive applications.

2. Description of Related Art

When seals between a rotary or reciprocating shaft and a housing is subject to a high pressure medium such as drilling mud, and/or the shaft rotates or reciprocates at a high velocity, failure of the seals occurs relatively quickly. In order to extend the life of the seals it is necessary to reduce the pressure on, at least, the upstream seal that faces the pressure-applying medium.

This is conventionally accomplished by diverting the source of the high pressure, such as drilling mud, past one side of the seal through, for example, a labyrinth seal, so as to provide a fluid pressure on the opposite side of the seal that is substantially the same as the fluid pressure on the first side of the seal. The fluid pressure caused by the diverted drilling mud or other fluid may then be transferred through a lubricant-filled chamber to a piston that expands the chamber in response to pressure on the bearing seal, and a lubricant source to replace lost lubricant. Examples of this type of pressure-equalization arrangement are found in U.S. Pat. Nos. 4,225,000, 4, 324,299, 4,325,299, and 4,548,283. Although effective to relieve pressure, this type of sealing arrangement is relatively costly to implement.

Alternative to use of fluid diversion and a piston, particular when the pressure-applying medium is abrasive and non-lubricating, is to use multiple floating barrier lip seals and a lubricant-filled chamber to directly transfer pressure away from the upstream seal that faces the source of fluid pressure. For example, in an arrangement proposed by Bal Seal Engineering Co. Inc., pressure applied by a fluid on a first floating barrier lip seal, is transferred by a medium such as lubricating fluid to a second floating barrier lip seal, which is surrounded by good lubricating media. Since the rear seal may be optimally lubricated it is capable of resisting differential pressure, while the first seal is pushed into equilibrium and therefore less subject to wear by the more abrasive pressure-applying fluid. In addition, in the sealing arrangement proposed by the Bal Seal company, some configurations have a third seal, rear facing, which is back-to-back with the second seal to give bi-directional sealing at a rear seal position.

The Bal Seal arrangement is much simpler than the arrangement described in the above-cited patents, and is especially suitable for applications in which complete isolation is required, such as downhole drilling applications. However, the arrangement only relieves pressure on the seal that is exposed to the abrasive pressure-applying media. All of the pressure is transferred to the second seal through the single lubricant chamber. As a result, the lifetime of the seals is still less than optimal. In addition, failure of either seal leaves the other seal exposed to maximum pressure as well as to the abrasive media, which can have catastrophic results.

### SUMMARY OF THE INVENTION

It is accordingly a first objective of the invention to provide a seal arrangement for high pressure rotary swivel or top drive systems, or reciprocating systems, that includes a self-balancing design to allow the seals to operate under high pressure and high velocity conditions.

It is a second objective of the invention to provide a system and method of sealing a rotating or reciprocating shaft that not only transfers pressure away from the upstream, high pressure seal, but that reduces pressure on the downstream seal, without the need for fluid diversion and/or complex piston-based pressure balancing systems and methods.

It is a third objective of the invention to provide a system and method of sealing a rotating or reciprocating shaft that provides a degree of redundancy to reduce the chance of catastrophic failure upon breach of one of the seals.

In accordance with the principles of a preferred embodiment of the invention, seal balancing is accomplished by providing a first grease balancing chamber bordered by a pair of seals and at least one additional grease balancing chamber bordered by one of the first pair of seals and by a third seal, and by compressing the grease in between the additional grease chambers by the movement of the first seal, due to pressure acting on this seal by system internal pressures, so as to distribute pressure from the first seal to multiple downstream seals. Preferably, each grease balancing chamber is filled with extreme pressure grease.

The seals are preferably floating barrier lip seals, although one or more of the seals may be replaced by functionally equivalent types of seals depending on the specific application, or additional seals such as o-rings may be added either downstream or upstream of the main seals. If floating barrier lip seals are used, the floating barrier lip seals may be short or full lip, and may including a U-cup in which is placed a resilient member, such as (by way of example and not limitation) a canted or standard coil spring, finger-type energizing elements, or the like.

Preferably, the system of the invention includes at least a third grease balancing chamber to reduce the pressure on each individual seal and provide for additional safety if the first seal fails under system pressure.

In addition, according to an especially advantageous implementation of the seal balancing system of the invention, the balancing chambers may be arranged such that the grease in between the seals can be replenished through ports provided in the supporting housing for the rotary swivel or top drive system, thereby extending the life of the seal assembly by allowing grease to lubricate the seal faces by extruding grease from each grease chamber.

### BRIEF DESCRIPTION OF THE DRAWINGS

FIG. 1 is a cross-sectional view of a seal balancing system constructed in accordance with the principles of a preferred embodiment of the invention.

### DETAILED DESCRIPTION OF THE PREFERRED EMBODIMENTS

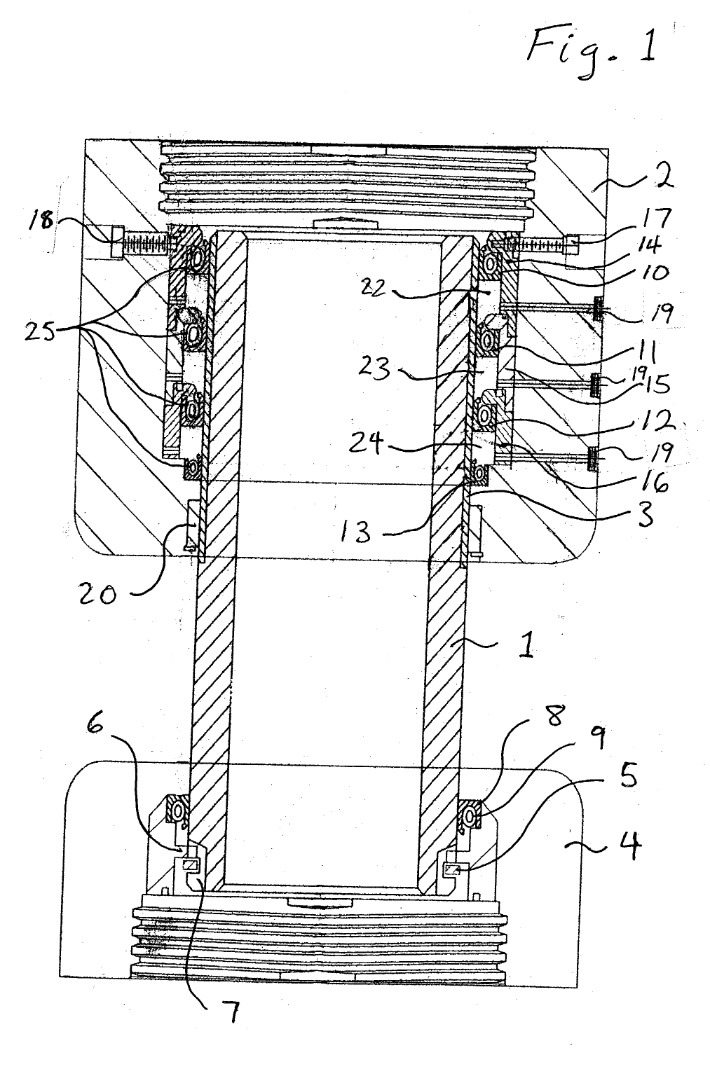

FIG. 1 illustrates a self-balancing seal arrangement for a high pressure rotary swivel or top drive system, or a reciprocating system, which includes a self-balancing design that allows the seals to operate under high pressure and in high velocity applications, in accordance with the principles of a preferred embodiment of the invention. The self-balancing seal arrangement includes a plurality of seals extending between a rotating or reciprocating shaft 1, such as the washpipe of an oil drilling rig, and a stationary or non-rotary assembly 2, such as the housing of a rotary swivel system for the washpipe.

As illustrated, one end of the shaft 1 includes a wear sleeve 3 for engagement with an alignment bushing 20 on the stationary or non-rotary assembly 2, while the other end of shaft 1 is secured to a coupling structure 4 by a pin 5, slot 6, snap ring 7 and floating lip seal 8 with a captivated resilient member 9. It will be appreciated, however, that the shaft 1, coupling structure 4, pin 5 and slot 6, snap ring 7, seal 8, and related structures form no part of the present invention and may be freely varied by those skilled in the art, and that the invention may be adapted for use in connection with a wide variety of shaft and housing structures for high pressure rotary swivel or top drive systems, including systems designed for use in land, inland barge, offshore drilling, or production platform facilities, as well as in other contexts involving high pressure rotary, swivel, or reciprocating drive systems.

In order to provide a self-balancing seal, the shaft sealing system of the preferred embodiment includes a plurality of annular seals 10-13 surrounding the shaft 1. In addition, the illustrated stationary or non-rotary assembly 2 includes a plurality of annular seal supporting structures 14-16 held in place by screws 17 and 18 for supporting and limiting upward movement of seals 10-13 upon application of pressure. Respective first, second, and third annular chambers 22-24 are formed between the supporting structures 14-16 and wear sleeve 3, and between the respective seals 10-13. Chambers 22-24 are filled with an extreme pressure grease of a type that is known to those skilled in the art and commercially available. Each chamber communicates with an outside of the housing 2 by means of a respective grease service port 19 that permits the grease to be replenished.

The seal balancing is accomplished by compressing the extreme pressure grease in between the first, second, and third grease chambers 22-24 by the movement of seals 10-12 due to pressure acting on these seals by system internal pressures. The grease in chambers 22-24 between the seals can be replenished through the provided ports 19, extending the life of the seal assembly by allowing the grease to lubricate the seal faces by extruding grease from each grease chamber.

Seals 10-13 are preferably floating barrier lip seals, although one or more of the seals may be replaced by functionally equivalent types of seals depending on the specific application, or additional seals such as o-rings may be added either downstream or upstream of the main seals. Even if the same type of seal is used for each of seals 10-13, the seals may have different dimensions. If floating barrier lip seals are used, the floating barrier lip seals may be short or full lip, and may including a U-cup in which is placed a resilient member 25, such as a canted or standard coil spring, finger type energizing elements, and so forth.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

We claim:

1. A balanced seal arrangement for high pressure rotary or reciprocating systems including a rotary or reciprocating shaft and a stationary assembly relative to which the shaft rotates or reciprocates, comprising:
a first balancing chamber bordered by a pair of seals and at least one additional balancing chamber bordered by one of the first pair of seals and a third seal, each balancing chamber being situated between the shaft and the stationary assembly, and each balancing chamber being filled with a lubricant, wherein the lubricant is compressed in between the additional balancing chambers by the movement of the first seal due to pressure acting on this seal by system internal pressures.

2. A balanced seal arrangement as claimed in claim 1, further comprising at least a third balancing chamber to further distribute pressure on the first seal and provide for additional safety if the first seal fails under system pressure.

3. A balanced seal arrangement as claimed in claim 1, wherein the lubricant is extreme pressure grease.

4. A balanced seal arrangement as claimed in claim 3, further comprising a plurality of ports in the stationary housing, wherein the balancing chambers are arranged such that the grease in between the seals can be replenished through the ports, thereby extending the life of the seal assembly by allowing lubrication of the seal faces by extruding grease from each grease chamber.

5. A balanced seal arrangement as claimed in claim 1, wherein said seals are floating barrier lip seals.

6. A balanced seal arrangement as claimed in claim 4, wherein said floating barrier lip seals have a cup-shape in which is positioned a resilient member.

7. A balanced seal arrangement as claimed in claim 5, wherein the resilient member is a coil spring.

8. A balanced seal arrangement as claimed in claim 1, wherein said lubricating fluid is extreme pressure grease.

9. A balanced seal arrangement as claimed in claim 1, wherein the stationary assembly and shaft are part of a rotary swivel or top drive system for an oil drilling rig.

10. A method of sealing a shaft in a high pressure rotary systems, comprising:
providing a first grease balancing chamber bordered by a pair of seals and at least one additional grease balancing chamber bordered by one of the first pair of seals and a third seal, each grease balancing chamber being filled with extreme pressure grease; and
compressing the seal in between the additional grease chambers by the movement of the first seal due to distribute pressure between the one of the first pair of seals and the third seal.
